(19) United States
(12) Patent Application Publication
(10) Pub. No.: US 2003/0159346 A1
(43) Pub. Date: Aug. 28, 2003

(54) Apparatus prolonging the life of cut flowers

(76) Inventor: Choon Kwang Jung, Seoul (KR)

Correspondence Address: GREENBLUM & BERNSTEIN, P.L.C., 1950 ROLAND CLARKE PLACE, RESTON, VA, 20191, US

(21) Appl. No.: 10/296,240

(22) PCT Filed: May 21, 2001
(86) PCT No.: PCT/KR01/00832

(30) Foreign Application Priority Data
Jun. 9, 2000 (KR) 2000/31598

(51) Int. Cl. A01G 5/00; A47G 7/00

(52) U.S. Cl. 47/41.01

(57) ABSTRACT

The present invention relates generally to an apparatus for prolonging the useful life of cut flowers. The present invention, more specifically, provides the apparatus comprising electric cooling module which generates cooling heat on the upper part and warming heat on the lower part by means of Peltier effect according to the supply of an electric current through the bottom part of container being put cut flowers in, thereby can not only prevent a water duct of cut flowers from getting clogged by restraining bacteria and fungi from generating but also keep up the fresh condition of cut flowers by enhancing the rate of water adsorption and respiration of the cut flowers, and ceramic layers laminated on inner part of the container which prevent the aging of cut flower from facilitating because of restraining the plant hormone (eg, ethylene) of cut flowers from generating by the extreme infrared rays radiated from the layers.

### BACKGROUND OF THE INVENTION

The present invention relates to an apparatus for prolonging the useful life of cut flowers, more specifically, to the apparatus comprising electric cooling module which generates cooling heat on the upper part and warming heat an the lower part by means of Peltier effect according to the supply of an electric current through the bottom part of container being put cut flowers in, so that a water duct of cut flowers can be prevented from getting clogged by restraining microorganism such as bacteria and fungi from generating and also the fresh condition of cut flowers can be maintained by enhancing the rate of water adsorption and respiration of cut flowers.

Generally men who reside in urban area have a lot of desire to go with the nature. The easiest method to satisfy the desire is to put flowers in a vase. That gives men the improvement of life quality, the realization of a cultural life, the stability of mind as well as the ornament of the interior. Cut flowers means to flower type put flowers which break off in the shape of a stem in a vase and flower gardening means to flower type planted flowers with root. But because cut flowers withers up easily, they can't be enjoyed by men for a long time.

The first reason of withering up cut flowers is owing to rising the water temperature of the vase. That is, microbial populations in the water increase very much because of keep up the water temperature of the vase at about 26° C. of room temperature.

The increase of microbial population cause the water duct in the stem of the cut flowers to get clogged, which causes the cut flowers to restrain the rate of water adsorption, to decrease the rate of respiration and to restrain the degradation of carbohydrate. Thereby cut flowers is easy to wither.

The second reason of withering up cut flowers is due to a plant hormone. That is, cut flowers is easy to wither owing to the plant hormone as called ethylene generated from cut flowers.

In the prior art, the additives was used to prevent cut flowers from withering. If the additives is mixed with the water of the vase, the life of the cut flowers can be increased about two times as long as normal. But because the material which the additives comprises is harmful to human body, changing the water of the vase is treated cautiously not to contact the water to the skin. Also, changing the water of the vase causes to water pollution by deteriorating the water quality due to the additives. Moreover, whenever the additives are needed, it arises the inconvenience to buy the additives at the flower shop.

To solve the disadvantage of the known method for prolonging the life of cut flowers, the object of the present Invention is to provide an apparatus for prolonging the life of cut flowers by keeping the temperature of the water which is adsorbed by cut flowers maintaining the low temperature of about 4° C., and preventing the facilitation of cut flowers' aging by means of restraining the generation of the plant hormone(eg, ethylene) of cut flowers.

In addition, another object of the present Invention is to provide an environmentally friendly apparatus which does not rely upon additives.

This object is achieved by the apparatus comprising electric cooling to module which generates cooling heat on the upper part and warming heat on the lower part by means of Peltier effect according to the supply of an electric current through the bottom part of container being put cut flowers in, and ceramic layers laminated on the inner part of the container which prevent the facilitation of cut flowers' aging by means of restraining the generation of the plant hormone with the extreme infrared rays radiated from the layers.

The apparatus of accomplishing the above objectives will become apparent from the detailed description of the invention.

### SUMMARY OF THE INVENTION

The present invention provides an apparatus comprising container being put cut flowers in; electric cooling module equipped with the bottom of the container which generates cooling heat on the upper part and warming heat on the lower part by means of Peltier effect according to the supply of an electric current through the bottom of the container; heat transfer plate of which the lower part contacts the electric cooling module and the upper part contacts the bottom of the container by means of putting on the female screw part in the male screw part of the container to transfer the cooling heat to the container; insulator which binds us the exterior part of the heat transfer plate and the electric cooling module; radiator of which the upper part is fixed to the insulator with a plurality of screws and the inner part is formed a plurality of the radiant fins; and exhaust fan fixed to the radiator to discharge the heat radiated from the radiator rapidly to the atmosphere.

The present Invention also provides the apparatus which further comprises ceramic layers laminated on the inner part of the container to restrain the plant hormone of the cut flowers from generating by the extreme infrared rays radiated the layers.

The present invention also provides the apparatus which further comprises steam containers equipped with on the both side of the radiant heat plate which cool the heat radiated from the radiator and evaporate the water by the radiated heat to provide moisture to cut flowers.

The present invention also provides the apparatus which further comprises vase without the bottom joined around the outer part of the container.

### BRIEF DESCRIPTION OF THE DRAWINGS

FIG. 1 is a front cross section view showing the structure of apparatus for prolonging the life of cut flowers according to the present invention,

FIG. 2 is a side cross section view showing the structure of apparatus for prolonging the life of cut flowers according to the present invention.

### DETAILED DESCRIPTION OF THE INVENTION

In accordance with the present invention, viability of fresh cut flowers is extended using the apparatus particularly comprising the electric cooling module and the ceramic layer laminated on the container put out flowers in. It surprisingly prolongs the fresh cut appearance of cut flowers, in many cases up. to two to three times as long as normal, over flowers that do not use the apparatus.

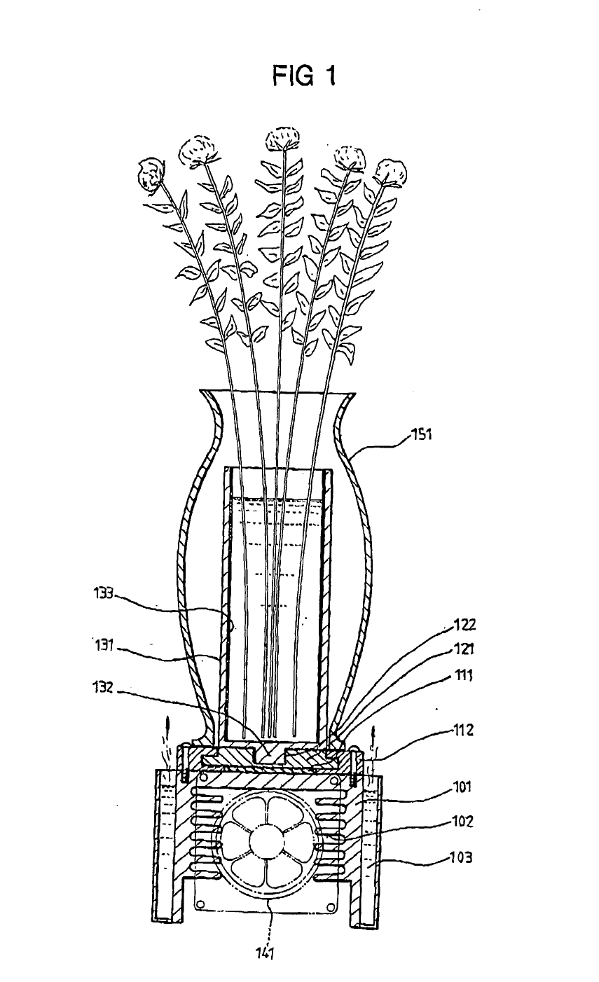

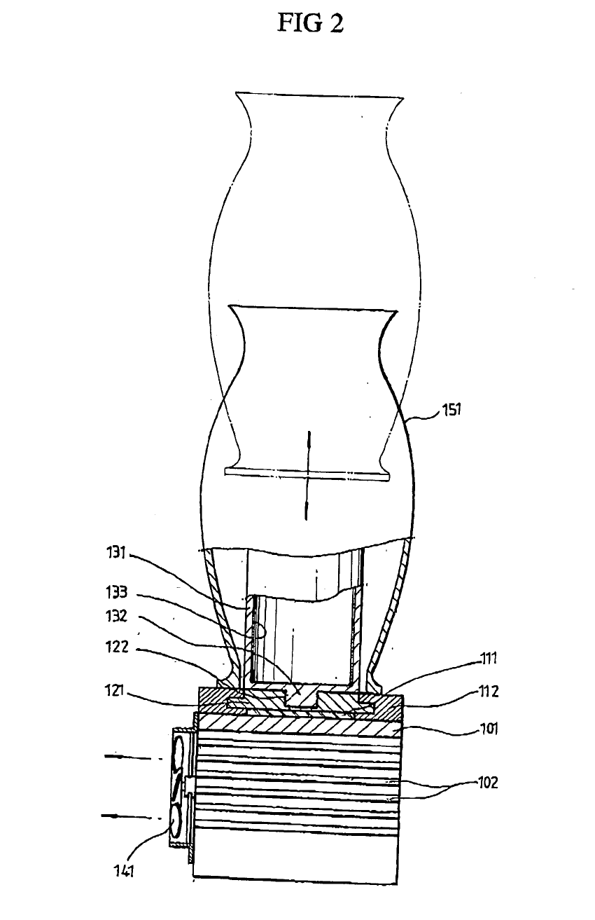

Referring now to the drawings, FIGS. 1 and 2, the present invention is described.

The present invention comprises a container(131) being put cut flowers in, an electric cooling module(111) equipped with the bottom of the container(131) which generates cooling heat on the upper part and warming heat on the lower part by means of Peltier effect according to the supply of an electric current through the bottom of the container(131), so that a water duct of cut flowers can be prevented from getting clogged by restraining microorganism such as bacteria and fungi from generating and also the fresh condition of cut flowers can be maintained by enhancing the rate of water adsorption and respiration of cut flowers,

a heat transfer plate(121) of which the lower part contacts the electric cooling module(111) and the upper part contacts the bottom of the container(131) by means of putting on the female screw part in the male screw part of the container(131) to transfer the cooling heat generated from the module(111) to the container(131),

an insulator(112) which binds up the exterior part of the heat transfer plate(121) and the electric cooling module(111) to support the plate(121) and the module(111), prevent mutual heat conduction between the cooling heat and the warming heat generated the upper and lower part of the module(111), and be put the vase(151) safely,

a radiator(101) of which the upper part is fixed to the insulator(112) with a plurality of screws and the inner part is formed a plurality of the radiant fins(102) to radiate the warming heat generated from the lower part of the module(111) to the atmosphere, and

an exhaust fan(141) fixed to the radiator(101) to discharge the heat from the radiator(101) to the atmosphere more rapidly.

The apparatus of the present Invention further comprises ceramic layers(133) laminated on the inner part of the container(131) to restrain the plant hormone such as ethylene of cut flowers from generating by the extreme infrared rays in order to prevent the facilitation of cut flowers' aging by ethylene.

The apparatus of the present invention also further comprises steam containers(103) equipped with on the both side of the radiator(101) which cool the heat radiated from the radiator(100) and then evaporate the water by the radiant heat to provide moisture to cut flowers in order to enjoy the fresh state of cut flowers visually.

Furthermore, the apparatus of the present invention further comprises a vase(151) vvithout the bottom joined around the outer part of the container (131) in order to seem to be put cut flowers in the vase(151).

Hereinafter, the function of the apparatus according to the present invention is described.

First, the suitable amount of water is filled the inner part of the container(131) and the steam containers(103) equipped with on the both side of the radiator(101), and then the vase(151) without bottom is joined around the outer part of the container (131) so to join the vase(151) with the insulator(112).

And then, various cut flowers are put in the container(131).

In the above mentioned state, the power is applied to the electric cooling module(111) and the exhaust fan(141). The electric cooling module(111) provided the power generates the cooling heat on the upper part and the warming heat on the lower part by Peltier effect.

The cooling heat generated from the upper part of the module(111) is transferred to the bottom of the container(131) rapidly through the heat transfer plate(121) contacted the upper part of the module(111).

Therefore, the water temperature of the container(131) is maintained about 4° C. The maintenance of the low temperature of about 4° C. results in being restrained the generation of the microorganism, which causes to last the fresh condition of cut flowers for a long time by increasing the rate of the adsorption and respiration owing to restraining the water duct of cut flowers from getting clogged.

The radiator(101) contacted the lower part of the module(111) radiates the warming heat radiated from the module(111) to the atmosphere. That is, a plurality of the radiant heat fins(102) formed in the inner part of the radiator(101) can radiate rapidly the warming heat to the atmosphere because the fins(102) contact the atmosphere broadly. But only the natural radiation of the warming heat which occurs in the radiator(101) and the fins(102) is not enough due to radiating the warming heat from the module(111) continuously for a long time.

To help the radiator, in the apparatus of the present invention, the warming heat can be discharged to the atmosphere from the radiator(101) and the fins(102) by driving the exhaust fan(141) fixed to the radiator(101).

The insulator(112) which binds up the exterior part of the heat transfer plate(121) and the electric cooling module(111) has the function which support the plate(121) and the module(111), prevent mutual heat conduction between the cooling heat and the warming heat generated the upper and lower part of the module(111), and can be put the vase(151) without the bottom safely.

The ceramic layers(133) laminated on the inner part of the container (131) restrain the generation of the plant hormone of cut flowers by the extreme infrared rays radiated from the layer(133) so that the facilitation of cut flowers' aging is restrained and the fresh condition of cut flowers lasts for a long time.

The object of the present invention can be achieved by sinking ceramic materials in the shape of bead, disk and pipe into the inner part of the container(131) instead of laminating the ceramic layers(133) on the inner part of the container(131).

The container(131) can be separated from the plate(121). That is, the male screw part (132) formed in the bottom of the container(131) can be separated from the female screw part (122) of the plate(121) by the rotation of the container(131), so that the change of water in the container(131) is easy and the inner part of the container(131) can be cleaned.

Furthermore, the vase(151) without the bottom joined around the outer part of the container(131) makes cut flowers in the container(131) seem to be put them in the vase(151). Therefore, the use of the various kinds of the vase(151) according to the atmosphere, the interior environment, the kind of cut flowers, and the taste of users can result in the suitable ornament with flowers. A flower basin without the bottom can be used instead of the vase(151).

The steam containers(103) equipped with on the both side of the radiator(101) evaporate the water in the steam containers(103) by the transfer of the radiant heat of the radiator(101). Therefore, evaporating the water result in cooling the heat radiated from the radiator(101) rapidly and providing moisture to cut flowers so that the fresh state of cut flowers can be enjoyed visually.

It is to be understood that the foregoing and specific embodiments are merely illustrative of the best mode of the invention and the principles thereof, and that various modifications and additions may be made to the apparatus by those skilled in the art, without departing from the spirit and scope of the present invention, which is therefore understood to be limited only by the scope of the appended claims.

What is claimed is;

1. (Amended) An apparatus for prolonging the life of cut flowers comprising:
a container for holding the cut flowers therein;
an electric cooling module provided at the bottom of the container, for generating cooling heat from the upper part thereof and warming heat from the lower part thereof with the Peltier Effect according to the supply of an electric current through the bottom of the container;
a heat transfer plate with the lower part thereof contacting the electric cooling module and the upper part thereof contacting the bottom of the container through screw engagement to transfer cooling heat to the water in the container;
an insulator joined at the exterior part of the heat transfer plate and the electric cooling module;
a radiator having the upper part thereof fixed to the insulator with a plurality of screws and the inner part provided with a plurality of radiant fins;
an exhaust fan fixed to the radiator to rapidly discharge the heat from the radiator to the atmosphere;
steam containers provided at both sides of the radiator to rapidly dissipate the heat from the radiator and evaporate the water therein with the radiated heat to provide moisture to the cut flowers; and
a vase with an open bottom to be put around the container.

2. (Amended) The apparatus of claim 1, further comprising a ceramic layer on the inner surface of the container to keep the plant hormone of the cut flowers from generating by far infrared rays.

3. (Cancelled)

4. (Cancelled)
